(19) United States
(12) Patent Application Publication
(10) Pub. No.: US 2008/0219212 A1
(43) Pub. Date: Sep. 11, 2008

(54) Handover Method for Mixed Mobile Communication System of Asynchronous Network and Synchronous Network

(76) Inventor: Young-Lak Kim, Seoul (KR)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/628,977

(22) PCT Filed: Jun. 7, 2005
(86) PCT No.: PCT/KR05/01704

§ 371 Date: Dec. 27, 2007

(30) Foreign Application Priority Data
Jun. 8, 2004 (KR) 10-2004-0041667
Jun. 8, 2004 (KR) 10-2004-0041668
Jun. 8, 2004 (KR) 10-2004-0041669
Jun. 8, 2004 (KR) 10-2004-0041670

(51) Int. Cl. H04Q 7/00

(52) U.S. Cl. 370/331

(57) ABSTRACT

A method for improving a success rate of handover in a mobile communication system in which an asynchronous network and a synchronous network are mixed is disclosed. The method comprises the steps of: an asynchronous system instructing an asynchronous modem of a mobile station to initiate a synchronous modem according to a handover request, the handover request that is generated from the mobile station when intensions of a forwarding and receiving signals between the mobile station and a node B of the asynchronous system are less than a predetermined intension; the asynchronous system determining a cell for the handover and instructing the mobile station to handover a synchronous system; the asynchronous modem requesting the synchronous modem to receiving a current communication according to a handover request of the asynchronous system to the asynchronous modem; the mobile station accessing the synchronous system; and the asynchronous releasing the communication with the mobile station.

### TECHNICAL FIELD

The present invention relates to a handover method in a mobile communication network, and more particularly to a method adapted to control a modem of a mobile communication terminal in a mobile communication system where asynchronous network and synchronous network are mixed, thereby improving a success rate of handover from the asynchronous network to the synchronous network.

### BACKGROUND ART

An asynchronous mobile communication system represented by Wideband Code Division Multiple Access (WCDMA) is a representative third generation (hereinafter referred to as a 3G) communication system that supports a large capacity and a high data transmission rate for voice and data. The asynchronous mobile communication system that supports a high speed mobility is excellent in service quality and transmission performance of a large data quantity as well.

Concomitant with the commercialization of 3G mobile communication service, research has been pursued to develop a multi mode multi band terminal that can be used both in a synchronous system for supporting a global roaming between mobile communication systems and asynchronous systems. By way of the multi mode multi band terminal, services of respectively different methods can be utilized in an asynchronous system area and a synchronous system area alike.

Although the asynchronous mobile communication system has a variety of advantages over the synchronous mobile communication system, there is required a large amount of costs for building a network, such that the asynchronous mobile communication system is being built around an area where services are much demanded. As a result, the synchronous mobile communication system is evolved to encompass a service area of the asynchronous mobile communication system. Under the circumstances, a handover is necessitated for providing a continuous service when a user moves from an asynchronous mobile communication system to a synchronous mobile communication system, and vice versa.

FIG. 1 is a flow chart for illustrating a conventional handover method from an asynchronous network to a synchronous network. The handover method is largely comprised of the steps of: a mobile communication terminal reporting neighboring cell information to an asynchronous network to instruct a handover to the synchronous network in response to a determination where the handover is necessitated at the asynchronous network (S10); the asynchronous network instructing the handover to a mobile communication terminal (S20); the mobile communication terminal being transferred from an asynchronous mode to a synchronous mode (S30); the mobile communication terminal accessing to the synchronous network after the mobile communication terminal completes the transition to the synchronous mode (S40); and releasing the access of the asynchronous network (S50).

To be more specific, a mobile communication terminal receiving services of an asynchronous mobile communication system periodically measures adjacent cell (base station) information and reports the information to a Radio Network Subsystem (RNS. Node B) of an asynchronous network (S101). The RNS refers to a radio environment measurement value of the mobile communication terminal at a current location to discriminate whether there is needed any handover, and if it is discriminated that there is needed a handover, the RNS reports to an asynchronous switch that there is needed the handover (S102). The RNS transmits mobile communication terminal information needed for handover and adjacent cell information at the same time.

The asynchronous switch checks the mobile communication terminal information and the adjacent cell information transmitted from the RNS, and if it is discriminated that a handover is needed to a synchronous mobile communication system area, the switch requests a base station system (BTS/BSC) to perform the handover (S103). Thereafter, a base station system allocates all direction channels to a synchronous modem unit of the mobile communication terminal to prepare the handover (S104).

When the synchronous switch transmits a response message in response to the handover request from the asynchronous switch, the asynchronous switch instructs the handover to an asynchronous modem unit of the mobile communication terminal via the RNS (S105. S106). The handover message contains information related to the synchronous mobile communication system, particularly the information for channel allocation.

The asynchronous modem unit of the mobile communication terminal that has received the handover instruction message from the RNS transmits to the asynchronous modem unit the handover instruction message including channel allocation information (S107), and the synchronous modem unit conducts a communication preparation process for accessing to the synchronous network. In other words, the synchronous modem unit of the mobile communication terminal is started by switch-on and warming-up processes (S108), obtains a pilot channel and a synchronous channel (S109. S110) to synchronize with the synchronous network, and receives timing information and system information from the synchronous network. As a result, the synchronous modem unit of the mobile communication terminal goes through an idle state (S111), and is transferred to a traffic state (S112).

After the driving of the synchronous modem unit is completed and transferred to the traffic state, the synchronous modem unit reports the completion of the handover to the base station of the synchronous network and transmits an inverse direction of frame to allow the connection between the mobile communication terminal and the synchronous network (S113). Successively, mode transition including vocoder switch between the asynchronous modem unit and the synchronous modem unit is carried out (S114).

Thereafter, according as the mobile communication terminal reports to the base station system that handover has been completed, the synchronous switch reports to the asynchronous switch that the handover has been completed to request the release of the connection (S115). At the same time, the asynchronous switch requests the RNS to release the connection with the mobile communication terminal, and following the release of connection with the mobile communication terminal by the RNS, the RNS reports the release to the asynchronous switch (S116) to complete the handover.

In the handover method thus explained, the synchronous modem unit of the mobile communication terminal is in a turned-off state while the mobile communication terminal is connected to the asynchronous network. However, when time has arrived where the mobile communication terminal is moved to a boundary between the asynchronous network and the synchronous network to cause the synchronous network to conduct the handover, the synchronous modem unit should be switched to a turned-on state. Under this circumstance, a time for driving the synchronous modem unit of the mobile communication terminal should be determined by the mobile communication terminal itself, such that there occurs a case where the handover fails due to the difference of state between the mobile communication terminal and the system.

To be more specific, an approximately 10 seconds are needed for driving the synchronous modem unit for establishing a communication with the synchronous mobile communication system when the multi mode multi band mobile communication terminal needs a handover while using the asynchronous mobile communication system service, such that the synchronous modem unit should be driven before communication with the asynchronous mobile communication system is terminated.

If the synchronous modem unit is not driven up to the complete breakaway from the range of the asynchronous mobile communication system, the handover is not conducted to disengage the call from being connected. If the synchronous modem unit is driven earlier than is necessary, two modems are simultaneously turned on to result in an over-consumption of power. It is therefore important to determine a timing when two modem units disposed at the multi mode multi band mobile communication terminal are turned on and off.

### DISCLOSURE OF INVENTION

### Technical Problem

The present invention is disclosed to solve the aforementioned problems and it is an object of the present invention to provide a handover method wherein a modem switch timing of a multi mode multi band mobile communication terminal for handover from an synchronous network to a synchronous network is determined by a mobile communication system to adapt the mode of the mobile communication terminal in response to the radio frequency network so that the success rate of handover can be improved.

It is another object of the present invention to provide a handover method wherein synchronous modem units of all mobile communication terminals entering a boundary between an asynchronous network and a synchronous network are driven to allow being transferred to a traffic state and the handover being transferred to the synchronous network when boundary cells are included in activated cells of the mobile communication terminal where the synchronous modems are driven so that the success rate of handover can be improved.

It is still another object of the present invention to provide a handover method wherein an asynchronous dummy pilot signal is transmitted from a synchronous base station embodied in a boundary between an asynchronous network and a synchronous network in a mobile communication system in which an asynchronous network and a synchronous network are mixed, and when a mobile communication terminal enters the boundary, a synchronous modem unit of the mobile communication terminal is driven, and the mobile communication terminal is handed over to the synchronous network when an intensity of a signal transmitted to and received from all the activated cells of driven mobile communication terminal is larger than that of a signal transmitted to and received from a base station that transmits a dummy pilot signal, thereby reducing the power consumption of the mobile communication terminal during the handover.

It is still further object of the present invention to provide a handover method whereby a synchronous modem of a mobile communication terminal entering a boundary between an asynchronous network and a synchronous network is driven at a time when a handover is necessary to thereby reduce the power consumption of the mobile communication terminal.

### Technical Solution

In accordance with one aspect of the present invention, there is provided a handover method of dual band dual mode mobile communication system disposed with an asynchronous modem and a synchronous modem in a mixed mobile communication network of an asynchronous mobile communication system and a synchronous mobile communication system, the method comprising the processes of: including adjacent cell information when a transmission/reception signal intensity with a node B of an asynchronous mobile communication system currently connected by a mobile communication terminal is smaller than a designated value to request a handover to the asynchronous mobile communication system so that the asynchronous mobile communication system instructs an asynchronous modem unit of the mobile communication terminal to drive a synchronous modem unit (first process); determining whether to perform a handover and a handover object cell in the asynchronous mobile communication system to instruct the handover to the synchronous mobile communication system (second process); the asynchronous modem unit of the mobile communication terminal requesting the synchronous modem unit a transfer to the traffic state in response to the asynchronous mobile communication system requesting handover to the asynchronous modem unit of the mobile communication terminal (third process); the mobile communication terminal being connected to the synchronous mobile communication system (fourth process); and the asynchronous mobile communication system releasing the connection with the mobile communication terminal (fifth process).

In accordance with another aspect of the present invention, there is provided a handover method of dual band dual mode mobile communication system disposed with an asynchronous modem and a synchronous modem in a mixed mobile communication network of an asynchronous mobile communication system and a synchronous mobile communication system, the method comprising the processes of: an asynchronous mobile communication system instructing an asynchronous modem unit of the mobile communication terminal to drive a synchronous modem unit when a boundary cell is included in an activated cell in response to the mobile communication terminal reporting to the asynchronous mobile communication system information of a cell currently connected by the mobile communication terminal and the activated cell (first process); the asynchronous mobile communication system referring to information of the activated cell collected from the mobile communication terminal to determine whether to perform a handover and a handover object cell and instructing the handover to the synchronous mobile communication system (second process); the asynchronous modem unit of the mobile communication terminal requesting the synchronous modem unit to transfer to the traffic state in response to the asynchronous mobile communication system requesting the handover to the asynchronous modem unit of the mobile communication terminal (third process); the mobile communication terminal connecting to the synchronous mobile communication system (fourth process); and the asynchronous mobile communication system releasing the connection with the mobile communication terminal (fifth process).

In accordance with still another aspect of the present invention, there is provided a handover method of dual band dual mode mobile communication system disposed with an asynchronous modem and a synchronous modem in a mixed mobile communication network of an asynchronous mobile communication system and a synchronous mobile communication system, wherein the synchronous mobile communication system is disposed at a boundary with the asynchronous mobile communication system with a base station transmitting a dummy pilot signal having a same frequency as that used by the asynchronous mobile communication system, the method comprising the processes of: the asynchronous mobile communication system instructing the asynchronous modem unit of the mobile communication terminal to drive the synchronous modem unit when a boundary cell is contained in an activated cell in response to the mobile communication terminal reporting to the asynchronous mobile communication system information of a cell currently connected by the mobile communication terminal and an activated cell (first process); determining whether to handover and a handover object cell at the asynchronous mobile communication system when a signal intensity of a cell transmitting a dummy pilot signal out of signals transmitted and received between the mobile communication terminal driven by the synchronous modem unit and an active cell, thereby instructing the handover to the synchronous mobile communication system (second process); the asynchronous modem unit of the mobile communication terminal requesting the synchronous modem unit to transfer to the traffic state in response to the asynchronous mobile communication system requesting the handover to the asynchronous modem unit of the mobile communication terminal (third process); the mobile communication terminal being connected to the synchronous mobile communication system (fourth process); and the asynchronous mobile communication system releasing the connection with the mobile communication terminal (fifth process).

In accordance with still further aspect of the present invention, there is provided a handover method of dual band dual mode mobile communication system disposed with an asynchronous modem and a synchronous modem in a mixed mobile communication network of an asynchronous mobile communication system and a synchronous mobile communication system, the method comprising the processes of: the asynchronous mobile communication system reporting to the mobile communication terminal whether a boundary cell exists in an adjacent cell of the mobile communication terminal (first process); the asynchronous modem unit of the mobile communication terminal discriminates whether to perform a handover if the boundary cell is contained in the adjacent cell of the mobile communication terminal, and the asynchronous mobile communication system instructing the handover to the synchronous mobile communication system in response to driving of the synchronous modem unit and reporting to the asynchronous mobile communication system a synchronization acquisition information (second process); the asynchronous modem unit of the mobile communication terminal requesting the synchronous modem unit to transfer to the traffic stage in response to the asynchronous mobile communication system requesting the asynchronous modem unit of the mobile communication terminal to perform the handover (third process); the mobile communication terminal connecting to the synchronous mobile communication system (fourth process); and the asynchronous mobile communication system releasing the connection with the mobile communication terminal (fifth process).

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a flow chart explaining a general handover method from an asynchronous network to a synchronous network;

FIG. 2 is a constitutional diagram of a mobile communication system according to the present invention;

FIG. 3 is a structural diagram of a mobile communication terminal according to the present invention;

FIG. 4 and FIG. 5 are flow charts explaining a handover method according to a first embodiment of the present invention;

FIG. 6 is a schematic drawing explaining a handover concept according to a second embodiment of the present invention;

FIG. 7 and FIG. 8 are flow charts explaining a handover method according to the second embodiment of the present invention;

FIG. 9 is a schematic drawing explaining a handover concept according to a third embodiment of the present invention;

FIG. 10 and FIG. 11 are flow charts explaining a handover method according to a fourth embodiment of the present invention;

FIG. 12 and FIG. 13 are flow charts explaining a handover method according the fourth embodiment of the present invention.

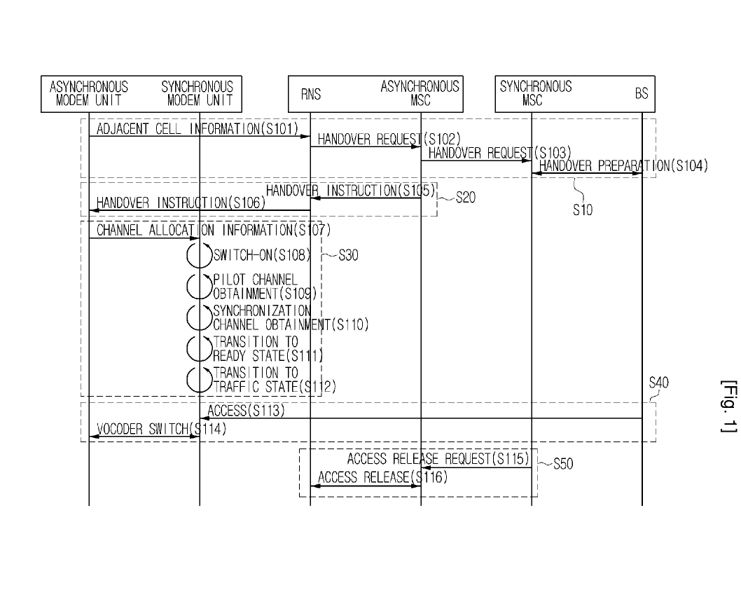

### BEST MODE FOR CARRYING OUT THE INVENTION

Preferred embodiments of the present invention will now be described in detail with reference to the annexed drawings.

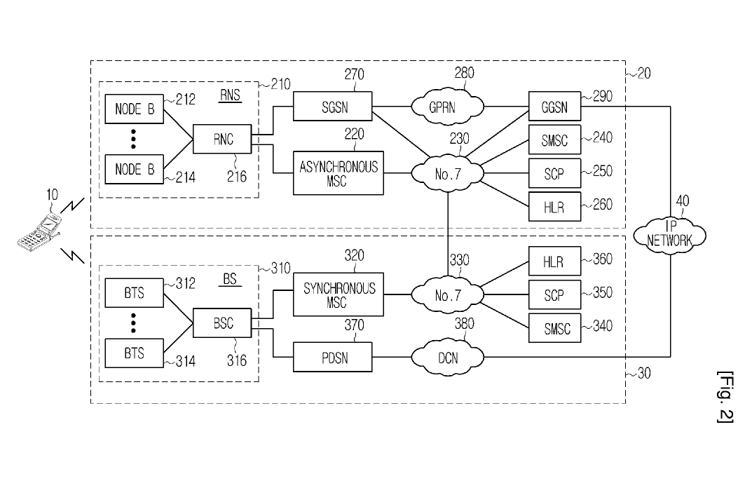

FIG. 2 is a constitutional diagram of a mobile communication system according to the present invention.

An asynchronous mobile communication system (20) includes a Radio Network Controller (RNC. 216) for controlling node Bs (212. 214) for establishing a communication with a mobile communication terminal (10) and a plurality of node Bs (212. 214), an asynchronous switch (MSC. 220) connected to the RNC (216) for conducting a call exchange in order to provide a service to the mobile communication terminal (10), a Short Message Service Center (SMSC. 240) connected via the MSC (220) and No. 7 common signal network (230), a Serving GPRS Support Node (270) connected between an intelligent network controller (SCP. 250), and Home Location Register (HLR. 260) and between the RNC (216) and a General Packet Radio Service (GPRS) network (280) for maintaining a position track of the mobile communication terminal (10) and conducting an access control and a security function, and a GGSN (Gateway GPRS Support Node. 290) connected via a SGSN (270) and the GPRS network (280), and accessed to the Internet Protocol (IP) network (40) for supporting a linkage with an outside packet.

The RNC (216) controlling radio resources for supervising and controlling the node Bs (212, 214) and the plurality of node Bs (212, 214) is particularly called a Radio Network Subsystem (RNS. 210).

Meanwhile, a synchronous mobile communication system (30) includes a Base Station Controller (BSC. 316) for controlling Base Stations (BTS. 312. 314) for supporting an establishment of radio section communication with the mobile communication terminal (10) and a plurality of base stations (312. 314), a switch (synchronous MSC. 320) for carrying out a call exchange by being connected to one or more base station controllers (316), a Short Message Service Center (SMSC. 340) connected via the switch (320) and No. 7 common signal network (330), a Packet Data Service Node (PDSN. 370) connected with an intelligent network controller (SCP. 350), a home location register (HLR. 360) and a base station controller for providing a packet data service to subscribers, and a Data Core Network (DCN. 380) for supporting a connection between the Packet Data Service Node (370) and IP network (40).

A base station controller (316) supervising and controlling the base stations (312. 314) and the plurality of base stations is particularly called a base station system (BS. 310).

Switches (220. 320) of an asynchronous network mobile communication system (20) and a synchronous network mobile communication system (30) which are interconnected by No.7 common signal network (230. 330) transmit and receive information necessary for handover of the mobile communication terminal (10).

The HLRs (260. 360) which can be embodied by dual stack home location register store and control subscriber information, value-added service use state and the like, and provide subscriber information in response to request from the switches (220. 320).

A boundary between the asynchronous network mobile communication system (20) and the synchronous network mobile communication system (30) may be formed with a handover-exclusive base station system for supporting handovers of mobile communication terminals. The base station system thus explained does not receive new calls from the asynchronous mobile communication system but is used only for handover.

When the mobile communication terminal is accessed to the handover-exclusive base station thus explained, the handover-exclusive base station notifies a state via a System Information Block (SIB) that the mobile communication terminal has arrived at a boundary if the mobile communication terminal is turned off, and if the mobile communication terminal is under traffic state, the handover-exclusive base station notifies via radio environment measurement control message.

Furthermore, a boundary between the asynchronous network mobile communication system (20) and the synchronous mobile communication system (30) may be formed with a base station system for transmitting an asynchronous dummy pilot signal in order to support the handover of the mobile communication terminal and a dummy cell area.

In the present invention, the mobile communication terminal, if located at a boundary between the asynchronous mobile communication system and the synchronous mobile communication system, receives the dummy pilot signal to establish a radio link and to drive the synchronous modem unit, while the asynchronous mobile communication system (20) determines the handover to cause the mobile communication terminal to be handed over to the synchronous mobile communication system (30) when an intensity of a signal transmitted to and received from all the activated cells is larger than that of a signal transmitted to and received from a base station that transmits a dummy pilot signal.

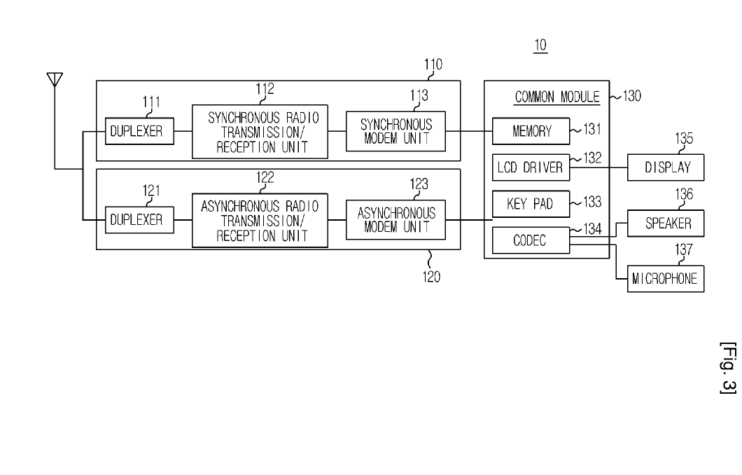

FIG. 3 is a structural diagram of a mobile communication terminal according to the present invention.

Referring to FIG. 3, a multi mode multi band mobile communication terminal (10) according to the present invention includes a module (110) for synchronous mobile communication service, a module (120) for asynchronous mobile communication service, a common module (130) and an antenna for handling frequency bands simultaneously for synchronous mobile communication service and asynchronous mobile communication service.

The synchronous module (110) includes a duplexer (111) functioning as a band pass filter for handling respective frequencies by separating same, a synchronous radio transceiver unit (112) for separating the transmitted and received waves to designated frequency bands and a synchronous modem unit (113) for handling a radio section protocol with the synchronous mobile communication system.

The asynchronous module (120) includes a duplexer (121) functioning as a band pass filter for handling respective frequencies by separating same, an asynchronous radio transceiver unit (122) for separating the transmitted and received waves to designated frequency bands and an asynchronous modem unit (123) for handling a radio section protocol with the asynchronous mobile communication system.

The common module (130) operating as a central processing unit for controlling the synchronous modem unit (113) and the asynchronous modem unit (123) and functioning as multi media is a part mounted with a software for a user interface, a value-added service, a mobile management, an access/secession control, a resource control and protocol processing. The common module (130) includes a memory (131), a Liquid Crystal Diode (LCD) driver (132) for displaying information on a display (135), a key pad (133) for receiving a signal inputted by a user, and a codec (134) for modulating and demodulating a voice signal inputted via a microphone (137) or outputted via a speaker (136).

According to one embodiment of the present invention, upon receipt of a report from an asynchronous network that a boundary cell is located in an adjacent cell under traffic state, the multi mode multi band mobile communication terminal is transferred to a stand-by state or an idle state by itself to measure a radio environment, and discriminates whether to perform a handover and acquires an establishment of synchronization with the synchronous network. As a result of the acquisition of establishment of synchronization, the multi mode multi band mobile communication terminal transmits the base station information (PN offset) to the asynchronous network to allow the subsequent handover procedures to be carried out.

According to another embodiment of the present invention, the multi mode multi band mobile communication terminal drives the stand-by state in response to the control of the asynchronous network, and measures a radio environment in response to the request of the asynchronous network. The multi mode multi band mobile communication terminal reports along the base station information (PN offset) that has obtained the synchronization when the radio environment measurement value is reported to allow the subsequent handover procedures to be carried out.

The state of synchronous modem unit of a mobile communication terminal can be classified into a turned-off state, a stand-by state, a ready or idle state and a traffic or busy state. The ready state means a state where a synchronization with the synchronous network is acquired and only reception of overhead message is possible. The stand-by state means a state where a mobile communication terminal is transferred to a ready state and is again transferred to a low power mode in which transmission/reception of modem is stopped. Generally, it takes approximately 10 seconds to transfer to a stand-by state after a power of a synchronous modem unit of a mobile communication terminal is turned on, and it takes approximately 2 seconds to transfer from a stand-by state to a traffic state.

Because it needs approximately 10 seconds to drive a mobile communication terminal, the power consumption is increased to drive the mobile communication terminal too early, and if driven too late, call is discontinued such that it is important that the driving timing of a mobile communication terminal should be adequately determined in response to a radio environment between the mobile communication terminal and the mobile communication system.

Various methods are disclosed in the present invention to adequately determine the timing, details of which are given below.

### First Embodiment

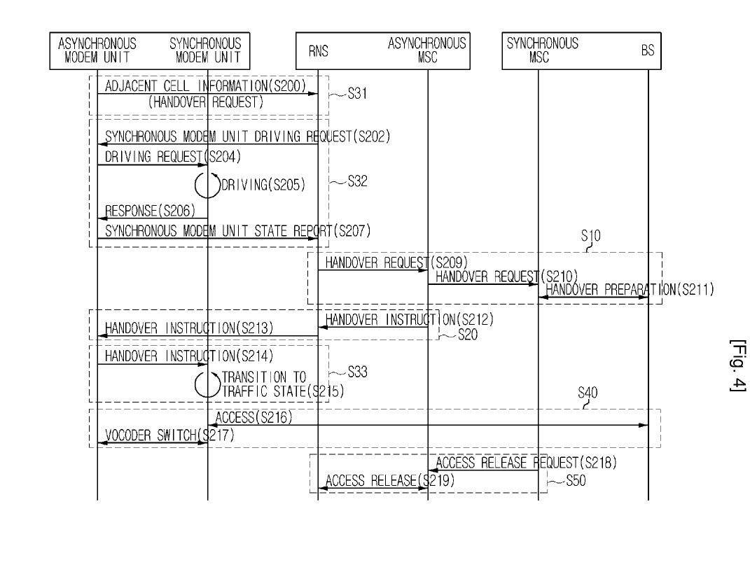

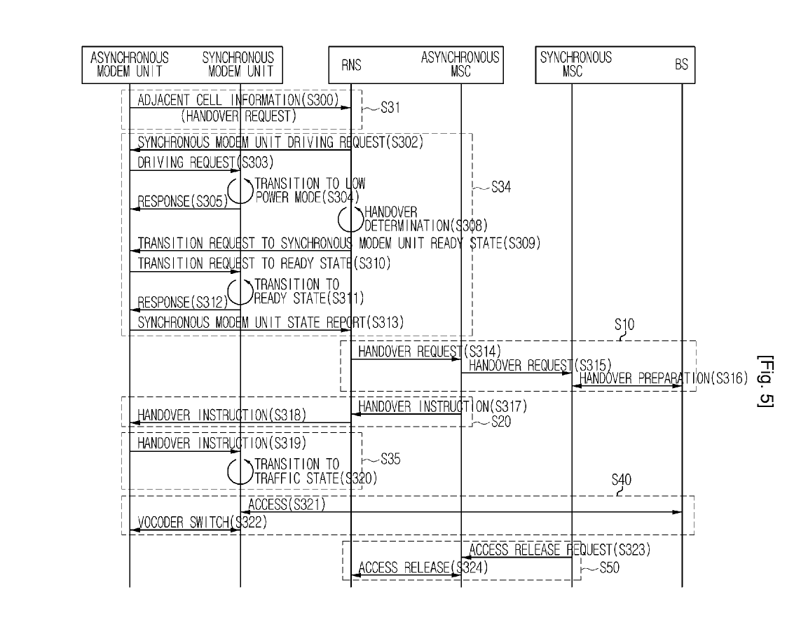

A method is disclosed in the first embodiment of the present invention. The method is such that, where a mobile communication terminal measures an adjacent cell information, and if the mobile communication terminal reports a situation to an asynchronous network, the situation being that an intensity of a signal transmitted to and received from a currently contacting cell gets lower than a predetermined value, and the mobile communication terminal instructs an asynchronous network to drive a synchronous modem unit of the mobile communication terminal for transition to a stand-by state or a ready state, and thereafter, a handover object cell is determined to instruct the mobile communication to perform a handover for transition to a traffic state. Details of which will be described with reference to FIGS. 4 and 5.

FIG. 4 is a flow chart for explaining a handover method according to the first embodiment of the present invention. A handover method according to the first embodiment of the present invention includes the processes of: an asynchronous network instructing a mobile communication terminal to drive a synchronous modem unit (S32) in response to the mobile communication terminal reporting to the asynchronous network a currently-connecting cell information and an adjacent cell information (S31); instructing a handover to a synchronous network (S10) in response to a discrimination that a situation occurs that a handover is necessary based on an adjacent cell information received by the asynchronous network from the asynchronous network; the asynchronous network instructing the handover to the mobile communication terminal (S20); the synchronous network of the mobile communication terminal being transferred to traffic state (S33); the mobile communication terminal being accessed to the synchronous network following transition to a synchronization mode (S40); and releasing the access with the asynchronous network (S50).

The process of the asynchronous network instructing the synchronous modem unit of the mobile communication terminal to drive (S32) may be a process of the mobile communication terminal being instructed to be transferred to a stand-by state, or a process of the mobile communication terminal being instructed to be transferred to a ready state.

In case S32 being the process of the mobile communication terminal being instructed to be transferred to a stand-by state, the mobile communication terminal carries out a process of releasing a low power mode at S33 for transition to a ready state, and to a traffic state. Meanwhile, if S32 is the process where the mobile communication terminal is instructed for transition to ready state, the mobile communication terminal is directly transferred to a traffic state at S33.

To be more specific, the mobile communication terminal receiving the services of the asynchronous mobile communication system periodically measures the adjacent cell (base station) information and reports a radio environment measurement value to the RNS (210) of the asynchronous network if intensity of a signal transmitted to and received from the currently-connecting node B is smaller than that of a designated value (S200).

Thereafter, the RNS (210) requests the asynchronous modem unit of the mobile communication terminal to drive the synchronous modem unit (S202). Successively, the asynchronous modem unit transmits a driving instruction to the synchronous modem unit (S204) to drive the synchronous modem unit (S205), which is reported by the synchronous modem unit to the asynchronous modem unit (S206). As a result, it may be possible to further carry out a process of the asynchronous modem unit reporting to the RNS (210) that the synchronous modem unit is driven (S207).

The asynchronous modem unit (220) may instruct the asynchronous modem unit that the synchronous modem unit be transferred to a stand-by state, or a ready state. In case of instruction to transfer to the stand-by state, the synchronous modem unit conducts a switch-on and warming-up processes to acquire a pilot channel and a synchronous channel for transition to a ready state and again for transition to a low power mode. Meanwhile, in case of instruction to transfer to the ready state, the synchronous modem unit carries out the switch-on and warming-up processes to acquire a pilot channel and a synchronous channel, and to again acquire system information in response to establishment of a synchronization with the synchronous network.

Successively, the RNS (210) refers to the adjacent cell information received from the mobile communication terminal to discriminate whether to perform a handover, and if it is necessary to perform the handover, the RNS (210) reports to the asynchronous switch (220) that handover is necessary (S209).

The asynchronous switch (220) checks the mobile communication terminal information, adjacent cell information, base station information and the like received from the RNS (210), and it is deemed necessary to perform a handover to the synchronous mobile communication system area, the asynchronous switch (220) decides a handover object cell and requests the handover to the synchronous switch (320). The synchronous switch (320) in turn requests a handover to the BS (310) which allocates all direction channel to the synchronous modem unit of the mobile communication terminal to prompt the handover to be ready (S211).

Preferably, when the RNS (210) decides whether to perform the handover, the adjacent cell information reported from the mobile communication terminal is referred to, and handover is requested when the adjacent cells of the mobile communication terminal, i.e., the activated cells, are all boundary cells that are located at a border between the asynchronous network and the synchronous network.

In case a cell that is not a boundary cell is included in the activated cells establishing a radio link with the mobile communication terminal, the synchronous modem unit can be driven at an early stage to increase the power consumption, albeit excellent in handover efficiency if the RNS (210) requests a handover to the asynchronous switch (220) and proceeds the subsequent processes. As a result, whether to perform the handover should be determined by features of radio environment where the activated cells are all border cells, or can be determined when ratio of boundary cells relative to the activated cells exceeds a designated ratio.

Successively, when the synchronous switch (320) transmits a response message against a handover request of the asynchronous switch (220, the asynchronous switch (220) instructs a handover to the asynchronous modem unit of the mobile communication terminal via the RNS (210) (S212. S213). The handover instruction message contains channel allocation information such as system parameter and the like necessary for transition from an ready state to a traffic state.

The asynchronous modem unit of the mobile communication terminal having received the handover instruction message from the RNS (210) instructs a performance of handover to the synchronous modem unit (S214), whereby the synchronous modem unit is transferred to a traffic state (S215). If the instruction is given to transit to a stand-by state of the synchronous modem unit at S202, the synchronous modem unit of the mobile communication terminal releases the low power mode and is transferred to a ready state where signals are transmitted to and received from the base station of the synchronous network, and if the instruction is given to transit to a ready state of the synchronous modem unit at S202, the synchronous modem unit of the mobile communication terminal is directly transferred to the traffic state.

Thereafter, the synchronous modem unit reports to the base station (310) of the synchronous network that the handover has been completed, and transmits a frame of reverse direction to thereby enable a connection between the mobile communication terminal and the synchronous network (S216). Following the connection between the synchronous modem unit and the synchronous network, an adaptive multi-rate (AMR) is transformed to an Enhanced Variable Rate Coder (EVRC) prompting a voiceless section during the procedures of the handover to be minimized (S217).

Successively, the synchronous switch (320) reports to the asynchronous switch (220) that the handover has been completed and requests to release the connection therebetween (S218). The asynchronous switch (220) requests the RNS (210) the release of the connection with the mobile communication terminal. The RNS (210) releases the connection with the mobile communication terminal and reports the disconnection with the mobile communication terminal (S219) to the asynchronous switch (220) to complete the handover.

In the earlier statement, description has been made about the handover method in which a mobile communication terminal periodically measures the intensity of signals transmitted to and received from the cells where radio links are established, and the mobile communication terminal drives the synchronous modem unit of the mobile communication terminal in response to the control of the asynchronous network when the intensity of the transmission/reception signals of cells currently receiving services are smaller than those of the predetermined value, and the synchronous modem unit is transferred to a traffic state in response the handover instruction for connection to the synchronous network following the determination of handover with the asynchronous network.

Under this circumstance, the synchronous modem unit of the mobile communication terminal is transferred to a stand-by state or a ready state in response to the request of the asynchronous network, and is again transferred to a traffic state in response to the handover instruction.

In the present invention, it is possible that the synchronous modem unit of the mobile communication terminal is transferred to the stand-by state from the turned-off state, and is transferred to the ready state from the stand-by state according to the determination of handover at the asynchronous network, and is transferred to the traffic state according to the handover instruction following decision of whether to carry out the handover and handover object cell at the asynchronous network. Regarding the above-mentioned method, description will be made with reference to FIG. 5.

FIG. 5 is a flow chart explaining the handover method according to another embodiment of the present invention.

Referring to FIG. 5, the handover method according to another embodiment of the present invention includes the steps of: the asynchronous network instructing the mobile communication terminal that the synchronous modem unit be transferred to stand-by state in response to the mobile communication terminal reporting to the asynchronous network the currently-connecting cell information and adjacent cell information (S31), and the asynchronous network determining whether to carry out the handover to prompt the synchronous modem unit to be transferred to the ready state (S34); the asynchronous network instructing the handover to the synchronous network (S10); the synchronous modem unit of the mobile communication terminal being transferred to traffic state (S35); the mobile communication terminal connecting to the synchronous network following completion of transition to the synchronous mode (S40); and releasing the connection with the asynchronous network (S50).

To be more specific, the mobile communication terminal receiving services of the asynchronous mobile communication system periodically measures the adjacent cell information to report the RNS (210) of the asynchronous network the radio environment measurement value when the intensity of transmission/reception signal with the currently connecting node B is larger than that of the predetermined value (S300).

As a result, the RNS (210) requests the asynchronous modem unit of the mobile communication terminal that the synchronous modem unit be driven in stand-by state (S302), and the asynchronous modem unit instructs the synchronous modem unit to be transferred to the stand-by state (S303), prompting the synchronous modem unit to be under stand-by state (S304), which is reported to the asynchronous modem unit by the synchronous modem unit (S305). It is possible that a further step may be carried out where the asynchronous modem unit reports the asynchronous switch (320) that the synchronous modem unit has been transferred to the stand-by state.

Successively, the RNS (210) refers to the adjacent cell information transmitted from the asynchronous modem unit of the mobile communication terminal at S300 to determine whether to perform the handover (S308), and then requests the asynchronous modem unit that the synchronous modem unit be transferred to a ready state (S309). Consequently, the asynchronous modem unit instructs the synchronous modem unit to transfer to the ready state (S310) such that the synchronous modem unit is transferred to the ready state from the stand-by state (S311), which is reported to the asynchronous modem unit by the synchronous modem unit (S312). Successively, the asynchronous modem unit reports the RNS (210) that the synchronous modem unit has been transferred to ready state (S313).

At this time, the synchronous modem unit conducts switch-on, warming-up processes, and a transferring process to the low power mode following acquisition of the pilot channel and synchronous channel in a bid to be transferred to the stand-by state from the turned-off state, and releases the low power mode for transition to the ready state from the stand-by state to transmit signals to and receives signals from the synchronous network.

Preferably, the adjacent cell information reported from the mobile communication terminal is referred to in determining whether to perform the handover at the RNS (210), and the handover is requested when the adjacent cells of the mobile communication terminal, i.e., the activated cells are all the boundary cells located at the border between the asynchronous network and the synchronous network. When the activated cells for establishing the radio links with the mobile communication terminal include cells which are not the boundary cells, and when the RNS (210) requests the asynchronous switch (220) of the handover and proceeds to conduct the subsequent processes, the synchronous modem unit of the mobile communication terminal is driven at an early stage to increase the power consumption, albeit excellent in handover efficiency. In that case, the determination of handover is made in consideration of the features of the radio environment if the activated cells are all boundary cells, and the handover is carried out if the ratio of the border cells relative to the activated cells is more than a predetermined level.

Successively, the RNS (210) reports the asynchronous switch (220) that the handover is needed (S314), and at this time, the RNS (210) transmits information of the mobile communication terminal necessary for the handover, adjacent cell information and the like at the same time. The asynchronous switch (220) checks the information of the mobile communication terminal, the adjacent cell information, the base station information and the like received from the RNS (210) to determine the handover object cell and requests the synchronous switch (320) the handover (S315). The synchronous switch (320) requests the base station (310) the handover where the base station (310) allocates all direction channel to the synchronous modem unit of the mobile communication terminal to allow the handover to be prepared (S316).

Successively, when the synchronous switch (320) transmits a response message to the handover request of the asynchronous switch (220), the asynchronous switch (220) instructs the asynchronous modem unit of the mobile communication terminal to perform the handover via the RNS (210) (S317. S318). Furthermore, the asynchronous modem unit of the mobile communication terminal that has received the handover instruction message from the RNS (210) instructs the synchronous modem unit to perform the handover (S319), whereby the synchronous modem unit is transferred to the traffic state (S320).

Subsequently, the synchronous modem unit reports the base station (310) of the synchronous network that the handover has been completed and transmits a frame of reverse direction to allow the connection to be made between the mobile communication terminal and the synchronous network (S321). Following the connection between the synchronous modem unit and the synchronous network, the Asynchronous Multi-Rate (AMR) is transformed to the Enhanced Variable Rate Codec (EVRC) to allow the voiceless section during the handover procedures to be minimized (S322).

After the connection between the synchronous modem unit of the mobile communication terminal and the synchronous network, the synchronous switch (320) reports the asynchronous switch (220) that the handover has been completed to request the release of the connection (S323), so that the asynchronous switch (220) requests the RNS (210) to release the connection with the mobile communication terminal. After the RNS (210) releases the connection with the mobile communication terminal, and reports the disconnection to the asynchronous switch (220) (S324), the handover is completed.

As stated earlier in the first embodiment, a mobile communication terminal periodically measures the intensity of signals transmitted to and received from the cells where radio links are established with the mobile communication terminal, and the synchronous modem unit of the mobile communication termianl is transferred to a turned-off state, stand-by state, traffic state in response the control of the asynchronous network when the intensity of the transmission/reception signals of cells currently receiving services are smaller than those of the predetermined value, and the synchronous modem unit of the mobile communication termianl is transferred to the traffic state in response the handover instruction of the asynchronous network, such that the synchronous modem unit is driven in a ready state at a time when the handover is necessary, and is transferred to the traffic state following the decision of the handover cell to thereby reduce the power consumption. At the same time, the synchronous modem unit is driven at an appropriate time according to the need to prevent the call failure when the handover is not successful.

### Second Embodiment

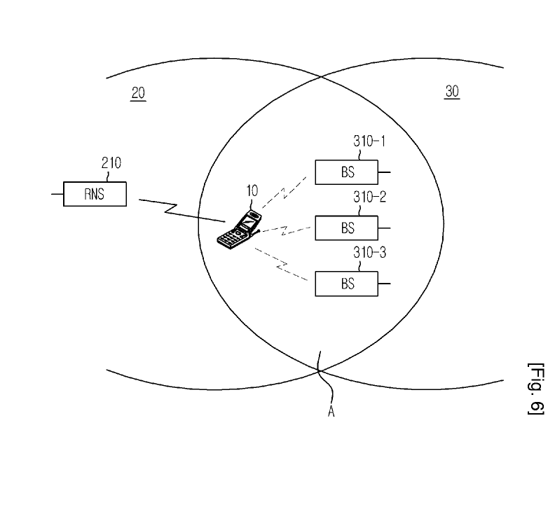

Furthermore, in the present invention, description is made on the handover method, wherein, when the mobile communication terminal enters a handover cell, the mobile communication terminal is driven to allow the asynchronous network to determine whether to handover the mobile communication terminal and the handover object cell, and the mobile communication terminal is made to be transferred to a traffic state to allow the synchronous network to perform the handover. Now, detailed description of the handover method according to the second embodiment of the present invention will be made with reference to FIGS. 6, 7 and 8.

FIG. 6 is a schematic drawing for explaining the handover concept according to the present invention.

When a mobile communication terminal connected to the RNS (210) at an area of the asynchronous mobile communication system (20) and using the service thereof is moved to the synchronous mobile communication system (30) to enter a border between the asynchronous mobile communication system (20) and the synchronous mobile communication system (30), i.e., the handover cell region (A), the mobile communication terminal is connected to the RNS (210) to receive the service and to establish a radio link with handover exclusive base station system (BS. 310-1, 310-3) of the synchronous mobile communication system (30). At this time, the cell covered by the handover exclusive base station system is called a boundary cell.

The mobile communication terminal periodically measures the currently-connected base station information and activated cell-related information where the radio link is established and reports the information to the RNS (210), where the RNS (210) checks if the boundary cell is contained in the activated cell where the radio link with the mobile communication terminal is established, and the synchronous modem unit is driven by way of the mobile communication terminal to request transition to the stand-by state or to the ready state. Thereafter, the RNS (210) checks if the activated cells for establishing the radio links while the mobile communication terminal is under driven state are all boundary cells, and if the activated cells are all boundary cells, the RNS (210) discriminates whether to perform the handover, and the asynchronous network discriminates the handover object cell and instructs the mobile communication terminal to be transferred to a traffic state.

In the present invention, it is possible that, if the activated cells where the mobile communication terminal establishes the radio links contain the boundary cells, the RNS (210) drives the synchronous modem unit and requests the mobile communication terminal to be transferred to the stand-by state, and if the activated cells of the mobile communication terminal under the stand-by state are all boundary cells, whether to handover is decided to allow the mobile communication terminal to be transferred to ready state, and the mobile communication terminal is allowed to be transferred to traffic state in response to the decision of the handover object cell by the asynchronous network.

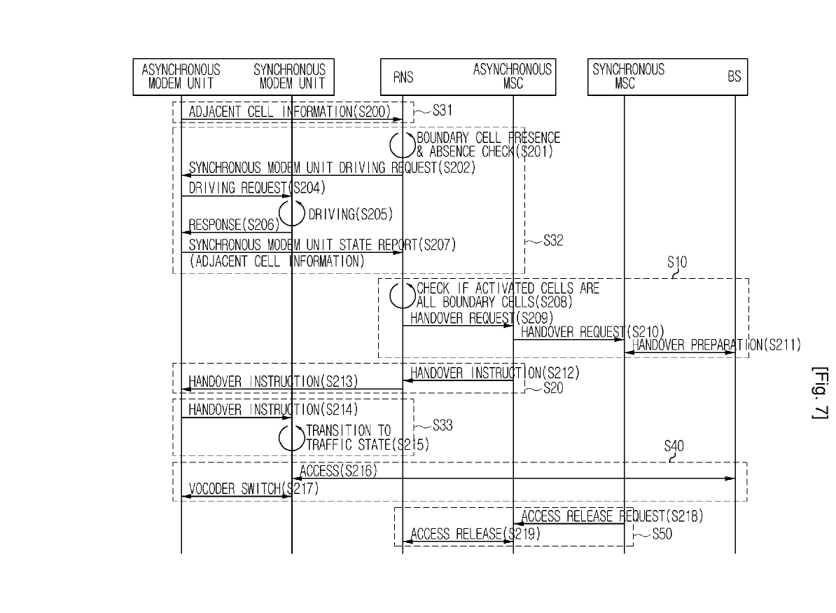

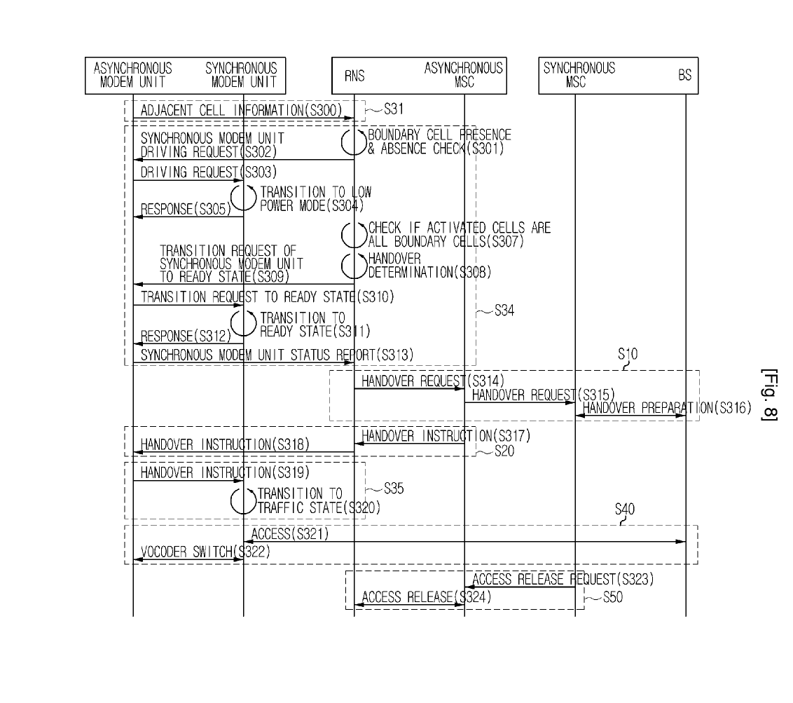

The handover method thus described will be explained in detail with reference to FIGS. 7 and 8.

In the following description, a boundary cell means a cell that is covered by the handover exclusive base station, and a base station means a base station system of a synchronous network to be connected by the mobile communication terminal.

FIG. 7 is a flow chart for explaining a handover method according to a second embodiment of the present invention.

Referring to FIG. 7, the handover method according to the second embodiment of the present invention includes the processes of: a mobile communication terminal reporting to an asynchronous network a currently-connecting cell information and adjacent cell information (S31); the asynchronous network checking the adjacent cell information to instruct the mobile communication terminal to drive a synchronous modem unit if boundary cells are contained in activated cells (S32); discriminating whether to perform the handover and handover object cell and instructing the synchronous network to perform the handover if the activated cells for establishing the driven mobile communication terminal and the radio link are all boundary cells (S10); the asynchronous network instructing the mobile communication terminal to perform the handover (S20); the synchronous modem unit of the mobile communication terminal to be transferred to traffic state (S33); the mobile communication terminal connecting to the synchronous network following the transition to synchronous mode (S40) and releasing the connection with the asynchronous network (S50).

The process (S32) of the asynchronous network instructing the synchronous modem unit of the mobile communication terminal to drive may be a process of instructing the mobile communication terminal to be transferred to stand-by state, or a process of instructing the mobile communication terminal to be transferred to ready state. If the process of S32 is a process of instructing the mobile communication terminal to be transferred to the stand-by state, the mobile communication terminal at S33 performs a step of releasing a low power mode to be transferred to the ready state and a step of transition to the traffic state.

Meanwhile, if the process of S32 is a process of instructing the mobile communication terminal to be transferred to the ready state, the mobile communication terminal is directly transferred to the traffic state at S33.

To be more specific, the mobile communication terminal receiving the services of the asynchronous mobile communication system periodically measures the currently connecting cell information and adjacent cell (base station) information and reports the information to the RNS (210) of the asynchronous network (S200).

Subsequently, the RNS (210) checks if the activated cells for establishing the mobile communication terminal with the radio links contain the boundary cells (S201), and if the boundary cells are contained, the RNS (210) requests the synchronous modem unit to drive (S202). Then the asynchronous modem unit transmits the driving instruction to the synchronous modem unit (S204) to prompt the synchronous modem unit to drive (S205), which is reported to the asynchronous modem unit by the synchronous modem unit (S206). As a result, it is also possible to add a step that the asynchronous modem unit reports the RNS (210) that the synchronous modem unit has been driven.

At step S202, the asynchronous switch (220) can instruct the asynchronous modem unit that the synchronous modem unit be transferred to the stand-by state, or to the ready state. If instruction is made for transition to the stand-by state, the synchronous modem unit performs the switch-on and warming-up processes to obtain a pilot channel and a synchronous channel and to transfer to ready state and to a low power mode. Meanwhile, if the instruction is made for transition to the ready state, the synchronous modem unit performs the switch-on and warming-up processes to obtain the pilot channel and the synchronous channel and synchronizes with the synchronous network to obtain the system information.

Successively, the RNS (210) refers to the adjacent cell information received from the mobile communication terminal to check if the activated cells of the mobile communication terminal driven at S205 are all the boundary cells (S208). If the boundary cells are included, the RNS (210) decides the performance of handover to report to the asynchronous modem unit (220) that the handover is needed (S209).

Preferably, when the RNS (210) decides whether to conduct the handover, the RNS (210) refers to the adjacent cell information reported from the mobile communication terminal to request the handover under the condition that the activated cells of the mobile communication terminal are all boundary cells.

If there are cells that are not the boundary cells among the activated cells for establishing the radio links with the mobile communication terminal, and when the RNS (210) requests the asynchronous switch (220) to perform the handover and to proceed the subsequent processes, the synchronous modem unit of the mobile communication terminal is driven at an early stage to increase the consumption of power, albeit excellent in handover efficiency.

Therefore, the decision of performing the handover should be made in consideration of the features of the radio environment, such that the handover can be made when the activated cells are all boundary cells, or ratio of the boundary cells relative to the activated cells is equal or greater than a predetermined ratio.

Meanwhile, the process of completing the handover following the decision of the handover is similar to that of the first embodiment of FIG. 4, such that further description thereto will be omitted herein for clarification of the present specification.

In the second embodiment of the present invention, when the mobile communication terminal enters a border between the asynchronous network and the synchronous network, the synchronous modem unit is driven, and radio environment of the mobile communication terminal is rechecked. Then, the mobile communication terminal is made to be transferred to the traffic state to thereby enable to save the consumption of power of the mobile communication terminal.

In the present embodiment, it is possible that, according as the synchronous modem unit of the mobile communication terminal is transferred to stand-by state in response to a drive request of the asynchronous network, and the synchronous modem unit is transferred to the ready state from the stand-by state in response to decision of handover on the part of the asynchronous network, and then, the synchronous modem unit is transferred to traffic state in response to the handover instruction following decision of handover object cell on the part of the asynchronous network. Detailed description thereto will be made with reference to FIG. 8.

FIG. 8 is a flow chart explaining the handover method according to the second embodiment of the present invention.

The handover method comprises the steps of: the mobile communication terminal reporting to the asynchronous network the currently-connecting cell information and adjacent cell information (S31); the asynchronous network instructing the mobile communication terminal to transfer the synchronous modem unit to the stand-by state if boundary cells are included in activated cells of the mobile communication terminal, and the asynchronous network deciding the handover and instructing that the synchronous modem unit be transferred to ready state if the boundary cells are included in the activated cells that establish the radio links with the mobile communication terminal of stand-by state (S34); the asynchronous network instructing the synchronous network that the handover be performed (S10); the asynchronous network instructing the mobile communication that the handover be performed (S20); the synchronous modem unit of the mobile communication terminal transferring to the traffic state (S35); the mobile communication terminal connecting to the synchronous network following the completion of the mobile communication terminal being transferred to the synchronous mode (S40); and releasing the connection with the asynchronous network (S50).

To be more specific, the mobile communication terminal receiving the services of the asynchronous mobile communication system periodically measures the adjacent cell (base station) information and reports the information to the RNS (210) of the asynchronous network (S200). Thereafter, the RNS (210) checks whether the activated cells establishing radio links with the mobile communication terminal are contained with the boundary cells (S301), and if the boundary cells are included, the RNS (210) requests the asynchronous modem unit of the mobile communication terminal that the synchronous modem unit be driven to stand-by state (S302). Then, the asynchronous modem unit instructs the synchronous modem unit to be transferred to stand-by state (S303) to allow the synchronous modem unit to be transferred to stand-by state (S304), and the synchronous modem unit reports the transition to the asynchronous modem unit (S305). As a result, it is possible to further perform a step that the asynchronous modem unit reports asynchronous switch (320) that the synchronous modem unit has been transferred to stand-by state.

Successively, the RNS (210) checks whether the activated cells that have established radio links with the mobile communication terminal that has been transferred to the stand-by state are all boundary cells (S307), and if the boundary cells are all contained, a decision is made as to whether to perform the handover (S308), and the RNS (210) instructs the asynchronous modem unit that the synchronous modem unit be transferred to ready state (S309). Thereafter, the asynchronous modem unit instructs the synchronous modem unit to be transferred to the ready state (S310) so that the synchronous modem unit is transferred from the stand-by state to the ready state (S311). The synchronous modem unit reports the transition to the asynchronous modem unit (S312). Next, the asynchronous modem unit reports to the RNS (210) that the synchronous modem unit has been transferred to ready state (S313).

Preferably, the RNS (210) decides the handover if the activated cells of the mobile communication terminal are all boundary cells.

If there is a case that some of the activated cells that are establishing radio links with the mobile communication terminal are not boundary cells, and when the RNS (210) requests the asynchronous switch (220) the handover to proceed the subsequent processes, the synchronous modem unit of the mobile communication terminal is driven at an early stage to increase the consumption of power, albeit excellent in the performance of handover. Therefore, the decision of performing the handover should be made in consideration of the features of the radio environment, such that the handover can be made when the activated cells are all boundary cells, or ratio of the boundary cells relative to the activated cells is equal or greater than a predetermined ratio.

Meanwhile, the process of completing the handover following the decision of the handover is similar to that of the first embodiment of FIG. 5, such that further description thereto will be omitted.

As mentioned in the second embodiment of the present invention, the asynchronous modem unit instructs that the synchronous modem unit of the mobile communication terminal be transferred to stand-by state if the activated cells that have established radio links with the mobile communication terminal contain the boundary cells, and the handover of the mobile communication terminal is decided so that the mobile communication terminal is transferred to ready state if the activated cells of the mobile communication terminal that have transferred to the stand-by state are all boundary cells. Because the mobile communication terminal is transferred to traffic state upon selection of the handover object cell, the synchronous modem unit is driven to the ready state at a time when the handover is needed, and the mobile communication terminal is transferred to traffic state following the decision of the handover, thereby enabling to reduce the consumption of the power of the mobile communication terminal. At the same time, the synchronous modem unit can be driven at an appropriate time when necessary to thereby enable to prevent the cutoff of calls due to failure of the handover.

### Third Embodiment

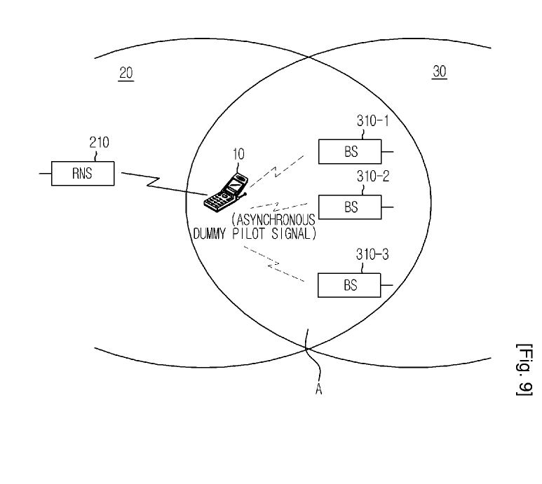

A handover method for mixed mobile communication system of asynchronous network and synchronous network according to the third embodiment of the present invention is presented in which, when a mobile communication terminal enters a border between an asynchronous network and a synchronous network, the mobile communication terminal is driven to determine the handover of the mobile communication terminal when a signal transmitted to and received from all the activated cells is larger than an intensity of a signal of a cell transmitting an asynchronous dummy pilot signal, and upon determination of a handover object cell, the mobile communication terminal is transferred to traffic state to thereby handover to the synchronous network, the concept of which will be described with reference to FIG. 9.

FIG. 9 is a schematic drawing for explaining a concept of handover according to a third embodiment of the present invention.

When the mobile communication terminal connected to the RNS (210) of the asynchronous mobile communication system (20) and using the services therefrom is moved to the synchronous mobile communication system (30) to enter a border (A) between an area of the asynchronous mobile communication system (20) and an area of the synchronous mobile communication system (30), the mobile communication terminal (10) is connected to the RNS (210) to receive the services therefrom and at the same time to establish a radio link with base station systems (BS: 310-1, 310-2, 310-3) of the synchronous mobile communication system (30).

At least one (310-2) of the base station systems of the synchronous mobile communication system (30) is a base station system for transmitting an asynchronous dummy pilot signal, and the dummy pilot signal has the same frequency as that of the asynchronous mobile communication system such that the mobile communication terminal (10) where the asynchronous modem unit is activated can easily search the signal transmitted from the base station of the synchronous mobile communication system (30).

In the present embodiment, if the mobile communication terminal (10) is located at a border (A), the adjacent cell information periodically measured and reported by the mobile communication terminal (10) includes the information indicating that the activated cells are boundary cells, which is recognized by the RNS (210) to prompt the synchronous modem unit of the mobile communication terminal to be driven under stand-by state or ready state.

Furthermore, the RNS (210) determines the handover if the intensity of a signal of the base station system (310-2) transmitting the dummy pilot signal out of signals transmitted to and received from the activated cells is maximized while the synchronous modem unit of the mobile communication terminal is driven. Thereafter, the asynchronous mobile communication system (20) determines the handover object cell and prompts the mobile communication terminal to be transferred to traffic state and to be handed over to the synchronous mobile communication system (30).

If the boundary cells are included in the activated cells where the radio links are established, the RNS (210) drives the synchronous modem unit by way of the mobile communication terminal (10) and allows it to be transferred to stand-by state, and the RNS (210) determines whether to perform the handover if an intensity of a cell within the base station system (310-2) transmitting a dummy pilot signal is maximized out of intensity of cells exchanging signals with the activated cell of the mobile communication terminal under stand-by state, to prompt the mobile communication terminal to be transferred to ready state. It is possible that upon decision of the handover object cell at the asynchronous network, the mobile communication terminal can be transferred to traffic state.

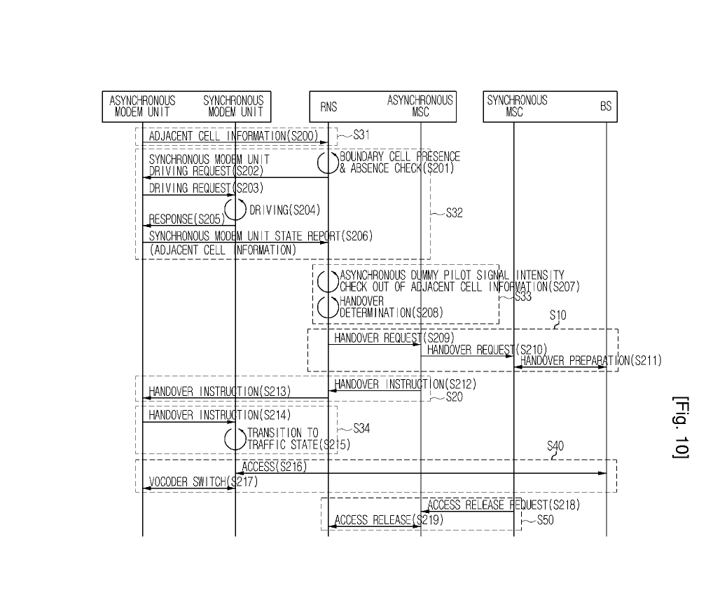

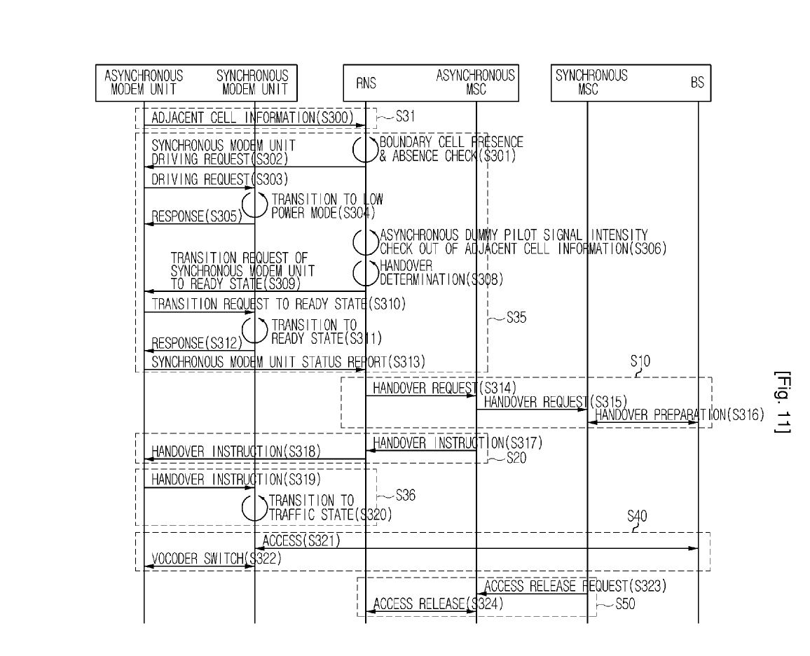

Now, the handover method according to the third embodiment of the present invention will be described in detail with reference to FIGS. 10 and 11.

FIG. 10 is a flow chart describing the handover method according to the third embodiment of the present invention.

The handover method according to the third embodiment of the present invention includes the processes of: the mobile communication terminal reporting the currently-connecting cell information and adjacent cell information to the asynchronous network (S31); instructing the mobile communication terminal to drive the synchronous modem unit when the adjacent cell information is checked by the asynchronous network and the boundary cell is included in the adjacent cell (S32); checking a magnitude of a signal of a cell establishing radio links with the driven mobile communication terminal to instruct whether to perform a handover if a magnitude of a cell of a cell transmitting a dummy pilot signal is maximized (S33); determining a handover object cell and instructing the handover to the synchronous network (S10); the asynchronous network instructing a handover to the mobile communication terminal (S20); the synchronous modem unit of the mobile communication terminal being transferred to traffic state (S34); the mobile communication terminal connecting to the synchronous network following completion of transition to the synchronous mode (S40); and releasing the connection with the asynchronous network (S50).

As in the previous embodiment of the present invention, in the third embodiment of the present invention, the process (S32) of the asynchronous network instructing the synchronous modem unit of the mobile communication terminal to drive may be a process of instructing the mobile communication terminal to transfer to ready state, or a process of instructing the mobile communication terminal to transfer to ready state. In S32, the mobile communication terminal performs the steps of: transferring to ready state by releasing the low power mode; and transferring to traffic state. Meanwhile, if S32 is a process of instructing the mobile communication terminal to transfer to ready state, the mobile communication terminal at S34 is directly transferred to the traffic state.

To be more specific, the mobile communication terminal receiving the services of the asynchronous mobile communication system periodically measures the currently-connecting cell information and adjacent cell (base station) information and reports the information to the RNS (210) of the asynchronous network (S200). Subsequently, the RNS (210) checks presence and absence of boundary cell out of activated cells establishing radio links with the mobile communication terminal (S201), and if the boundary cell exists, the RNS (210) requests the asynchronous modem unit to drive the synchronous modem unit (S202), whereby the asynchronous modem unit transmits a driving instruction to the synchronous modem unit (S203) to drive the synchronous modem unit (S204), and the synchronous modem unit reports this information to the asynchronous modem unit (S205).

Subsequently, it is also possible to further perform a step that the asynchronous modem unit reports the RNS (210) that synchronous modem unit has been driven including the adjacent cell information (S206).

At step S202, the asynchronous switch (220) may instruct the asynchronous modem unit that the synchronous modem unit be transferred to stand-by state, or ready state. If instruction is given to transfer to stand-by state, the synchronous modem unit performs the switch-on and warming-up processes to obtain a pilot channel and a synchronous channel, and processes of transition to ready state and then to the low power mode. Meanwhile, if the instruction is given to transfer to ready state, the synchronous modem unit performs the switch-on and warming-up processes to obtain the pilot channel and synchronous channel and to synchronizes with the synchronous network to obtain the system information.

Successively, the RNS (210) refers to the adjacent cell information received from the mobile communication terminal, and if an intensity of a cell transmitting signals to and receiving signals from the activated cells of the mobile communication terminal driven at S204 is larger than that of a signal of a cell to which the dummy pilot signals are transmitted to and received from (S207), the handover is determined (S208) and necessity of handover is reported to the asynchronous switch (220) (S209).

Meanwhile, once the handover is determined using the dummy pilot signal in the third embodiment, the remaining processes are the same as those of the previous embodiments of the present invention to complete the handover.

In the present invention, it is possible that the synchronous modem unit of the mobile communication terminal that has entered the border is transferred to stand-by state from the turned-off state in response to the driving request of the asynchronous network, and the handover is determined to be transferred to ready state from stand-by state when an intensity of a signal outputted from a cell transmitting a dummy pilot signal out of magnitudes of signals of the activated cells of the mobile communication terminal is maximized, and the handover object cell is determined by the asynchronous network to instruct the handover and to allow the mobile communication terminal to be transferred to traffic state, details of which will be explained with reference to FIG. 11.

FIG. 11 is a flow chart explaining the handover method according to the third embodiment of the present invention. The method comprises the processes of: the mobile communication terminal reporting the asynchronous network the currently-connecting cell information and adjacent cell information (S31); the asynchronous network instructing the mobile communication terminal that the synchronous modem unit be transferred to stand-by state when the boundary cells are included in the activated cells of the mobile communication terminal, and the asynchronous network determining the handover to instruct the synchronous modem unit to be transferred to ready state when intensity of a cell transmitting the dummy pilot signals is maximized in the magnitudes of activated cells establishing radio links with the mobile communication terminal under stand-by state (S35); the asynchronous network instructing the synchronous network to perform the handover (S10); the asynchronous network instructing the handover to the mobile communication terminal (S20); the synchronous modem unit of the mobile communication terminal to be transferred to traffic state (S36); the mobile communication terminal connecting to the synchronous network following completion of switch to the synchronous mode (S40); and releasing the connection with the asynchronous network (S50).

To be more specific, the mobile communication terminal receiving the services of the asynchronous mobile communication system periodically measures the adjacent cell (base station) information and reports the information to the RNS (210) (S300). The RNS (210) checks if the boundary cells are included in the activated cells establishing the radio links with the mobile communication terminal (S301), and if it is determined that the boundary cells are included, the RNS (210) requests the asynchronous modem unit of the mobile communication terminal that the synchronous modem unit be driven in stand-by state (S302). Thereafter, the asynchronous modem unit instructs the synchronous modem unit to be transferred to stand-by state (S303) to prompt the synchronous modem unit to be transferred to stand-by state (S304), and the synchronous modem unit reports the transition to the asynchronous modem unit (S305). Subsequently, it is possible to further perform a step of reporting that the synchronous modem unit has been transferred to stand-by state.

Successively, when the RNS (210) checks a magnitude of a signal from the activated cells establishing radio links with the mobile communication terminal that has transferred to stand-by state to again check if the magnitude of a signal of a cell transmitting the dummy pilot signals is maximized (S306), whether to perform the handover is determined (S308), and the RNS (210) requests the asynchronous modem unit that the synchronous modem unit be transferred to ready state (S309). Thereafter, the asynchronous modem unit instructs that the synchronous modem unit be transferred to ready state (S310), such that the synchronous modem unit is transferred to ready state (S311), which is reported to the asynchronous modem unit (S312). Next, the asynchronous modem unit reports the RNS (210) that the synchronous modem unit has been transferred to ready unit (S313).

The process wherein the RNS (210) is reported that handover is necessary and that the handover has been completed in the third embodiment of the present invention is similar to that of the first embodiment of FIG. 5 (S314 to S324) such that further explanation thereto is omitted herefrom.

As stated earlier, if the boundary cells are included in the activated cells establishing radio links with the mobile communication terminal, the asynchronous network instructs that the synchronous modem unit of the mobile communication terminal be transferred to stand-by state, and handover of the mobile communication terminal is determined and the mobile communication terminal is made to be transferred to ready state if an intensity of a cell transmitting the dummy pilot signal is larger than magnitude of an activated cell transmitting signals to and receiving signals from the mobile communication terminal that has been transferred to stand-by state. The mobile communication terminal is transferred to traffic state upon selection of handover object cell, and the synchronous modem unit is driven in ready state at a point when the handover is necessary, and once the handover object cell is determined, the mobile communication terminal is transferred to traffic state to thereby reduce the consumption of power.

### Fourth Embodiment

In the fourth embodiment of the present invention, if the mobile communication terminal is located at a border between the asynchronous network and the synchronous network, the asynchronous network reports this to the mobile communication terminal, and then the mobile communication terminal is self-driven to determine whether to perform the handover. A synchronization obtainment information of the synchronous network is reported to the asynchronous network to perform the handover.

Furthermore, in the present embodiment, if the asynchronous network requests the mobile communication terminal that radio environment is measured and reported, the mobile communication terminal is self-driven to be transferred to stand-by state to determine whether to perform the handover. The mobile communication terminal is transferred to ready state when it is necessary to perform the handover and to obtain a synchronization with the synchronous network and the synchronization obtainment information is reported to the asynchronous network along with the radio environment measurement result to enable to perform the handover.

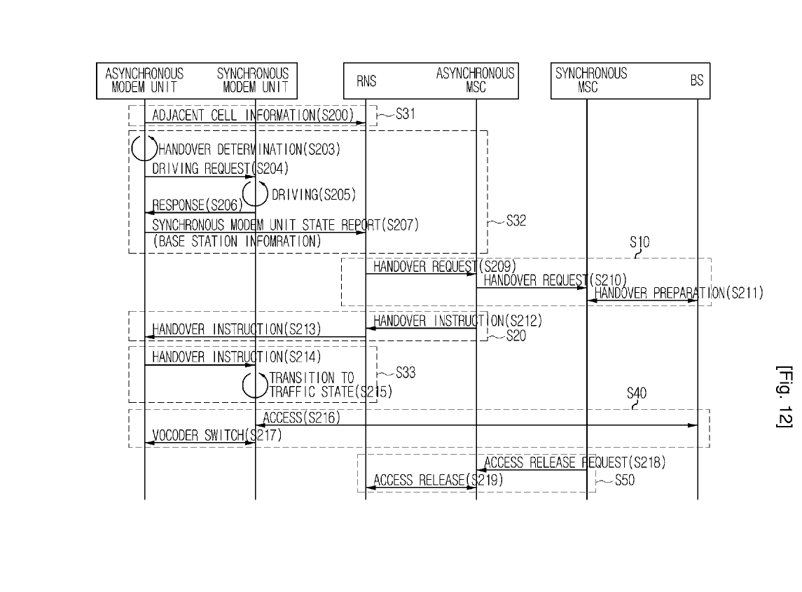

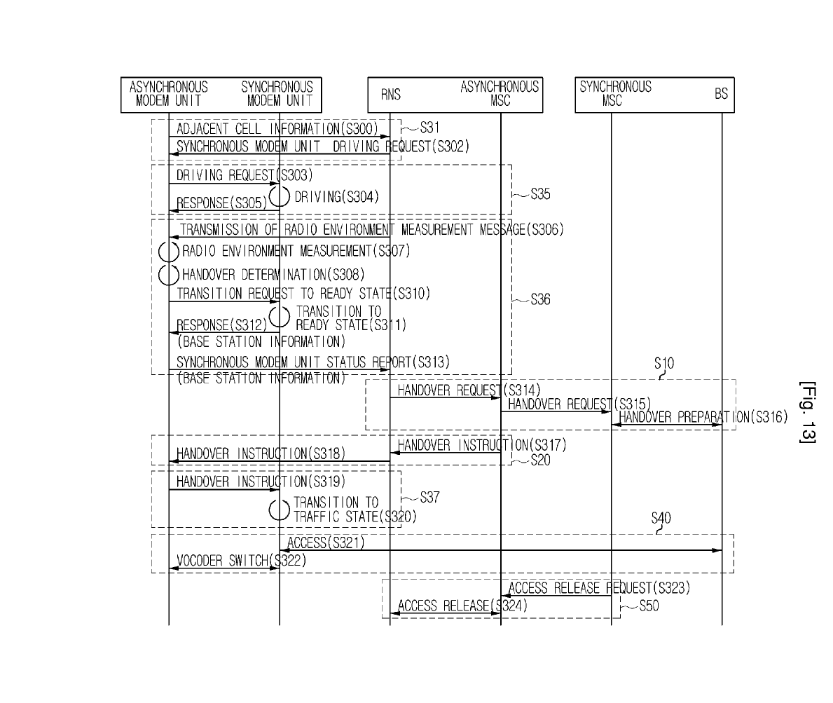

The handover method thus described will be explained in detail with reference to FIGS. 12 and 13.

FIG. 12 is a flow chart explaining the handover method according to the fourth embodiment of the present invention. The handover method according to the fourth embodiment of the present invention includes the processes of: the asynchronous network reporting to the mobile communication terminal whether a boundary cell is included in an adjacent cell according as the mobile communication terminal receiving service from the asynchronous mobile communication system reports the currently-connecting cell information and adjacent cell information to the asynchronous network (S31); the asynchronous modem unit of the mobile communication terminal determining whether to perform the handover if the boundary cell is contained in the adjacent cell and driving synchronous modem unit to obtain the synchronization if the handover is needed (S32); the asynchronous network instructing the synchronous network to perform the handover upon transmission of synchronization obtainment information of the synchronous modem unit to the asynchronous network by the mobile communication terminal (S10); the asynchronous network instructing the mobile communication terminal to perform the handover (S20); the synchronous modem unit of the mobile communication terminal transferring to traffic state (S33); the mobile communication terminal connecting to the synchronous network following completion of the transition to synchronous mode (S40); and releasing the connection with the asynchronous network (S50).

The process of the synchronous modem unit is driven by the asynchronous modem unit of the mobile communication terminal defines a process of the synchronous modem unit being transferred to stand-by state and then to ready state. The synchronization obtainment information of the synchronous modem unit defines PN offset information of the synchronous mobile communication system base station.

To be more specific, the mobile communication terminal receiving service of the asynchronous mobile communication system periodically measures the currently-connecting cell information and adjacent cell (base station) information and reports the information to the RNS (210) of the asynchronous network (S200). Then, the RNS (210) checks if the boundary cell exists in the adjacent cell establishing radio links with the mobile communication terminal, and the presence and absence of the boundary cell is reported to the asynchronous modem unit of the mobile communication terminal (S210).

If it is discriminate that the boundary cell is contained in the adjacent cell of the mobile communication terminal, the asynchronous modem unit refers to the intensity of a signal transmitted to and received from the currently-connecting cell. If the intensity of the signal is less than the threshold, the handover is determined (S203), and request is made to drive the synchronous modem unit (S204).

As a result, the synchronous modem unit is transferred to ready state from the stand-by state (S205). The transition from the turned-off state of the synchronous modem unit to stand-by state defines switch-on and warming-up process and process of obtaining pilot channel and synchronous channel and transition to low power mode, and the transition to ready state from the stand-by state defines releasing the low power mode and restarting the synchronous network and signal transmission and reception.

When the synchronous modem unit is driven according to the above-mentioned processes (S205), the synchronous modem unit reports its driving to the asynchronous modem unit (S206). At this time, information of being synchronized with the synchronous network, that is, PN offset information of synchronization-obtained base station is also reported. Then, the asynchronous modem unit reports to the RNS (210) that the synchronous modem unit has been driven, along with the synchronization obtainment information (base station PN offset) (S207). Subsequent processes are similar to those of the first embodiment of the present invention such that explanation thereto is omitted.

In the fourth embodiment of the present invention, according as the asynchronous network requests the mobile communication terminal to measure and report the radio environment, the mobile communication terminal measures the radio environment, and discrimination is made as to whether to perform the handover upon the measurement result of the radio environment to drive the synchronous modem unit and to obtain the synchronization with the synchronous network.

In response to report to the asynchronous network including the synchronization obtainment information in the radio environment measurement result, it is possible to perform the handover to a relevant synchronous base station that has obtained the synchronization, the detailed explanation of which will be given with reference to FIG. 13.

FIG. 13 is a flow chart explaining the handover method according to the fourth embodiment of the present invention.

In the fourth embodiment, it is allowed to omit the processes of the asynchronous network requesting the mobile communication terminal to drive the synchronous modem unit (S34) and the mobile communication terminal being transferred to stand-by state (S35), as these processes are not essential ones.

The handover method according to the fourth embodiment of the present invention includes the processes of: the asynchronous network instructing the synchronous modem unit of the mobile communication terminal to drive if the boundary cell is contained in the adjacent cell in response to the mobile communication terminal reporting the currently-connecting cell information and adjacent cell information to the asynchronous network (S34); the synchronous modem unit of the mobile communication terminal transferring to stand-by state (S35); the mobile communication terminal measuring the radio environment to determine whether to perform the handover and if necessary transferring to ready state to obtain the synchronization with the synchronous network in response to the asynchronous network requesting the mobile communication terminal to measure the environment and reporting the measurement (S36); the asynchronous network instructing the synchronous network to perform the handover in response to the asynchronous modem unit of the mobile communication terminal reporting to the asynchronous network the radio environment measurement result and synchronous obtainment information (S10); the asynchronous network instructing the mobile communication terminal to perform the handover (S20); the synchronous modem unit of the mobile communication terminal transferring to traffic state (S37); the mobile communication terminal connecting to the synchronous network following completion of transition to the synchronous mode (S40); and releasing the connection with the asynchronous network (S50).

To be more specific, the mobile communication terminal receiving the service of the asynchronous mobile communication system periodically measures the adjacent cell (base station) information and reports the information to the RNS (210) of the asynchronous network (S300). Then, the RNS (210) checks if the boundary cells are included in the adjacent cells establishing radio links with the mobile communication terminal or the adjacent cells are all the boundary cells, and if the boundary cells are contained in the adjacent cells or the adjacent cells are all the boundary cells, the RNS (210) requests the asynchronous modem unit of the mobile communication terminal to drive the synchronous modem unit in stand-by state (S302).

As a result, the asynchronous modem unit instructs the synchronous modem unit to transfer to stand-by state (S303) by which the synchronous modem unit is transferred to stand-by state S304), and the synchronous modem unit reports the transition to the asynchronous modem unit (S305). It is possible to add a process of the transition result of the synchronous modem unit being reported to the asynchronous switch (320) by the asynchronous modem unit.

Successively, the RNS (210) transmits the radio environment measurement control message to the asynchronous modem unit of the mobile communication terminal (S306). The radio environment measurement control message includes a condition for searching the synchronous network, that is, a condition of instructing a search of the synchronous network in case of occurrence of a special event or magnitude of signal of the asynchronous network. At the same time, the radio environment measurement control message includes object to be measured by the mobile communication terminal, scope of measurement value, measurement period, reporting method and the like, and the measurement object is classified by measurement ID.

The asynchronous modem unit having received the radio environment measurement control message from the RNS (210) measures a magnitude of a signal of the currently-connecting node B (S307) to determine that the handover is necessary if the magnitude of the signal is smaller than the threshold (S308) and requests the synchronous modem unit to transfer to ready state (S310). Then, the synchronous modem unit obtains the pilot channel and synchronous channel from the synchronous network to transfer to ready state (S311), and transmits the synchronization obtainment information(i.e., base station PN offset) to the asynchronous modem unit (S312). The asynchronous modem unit includes the synchronization obtainment information received from the synchronous modem unit in the radio environment measurement control message for transmission to the RNS (210) (S313). It is preferred that a process be added that, in case of omitting S34 and S34, the asynchronous modem unit requests the synchronous modem unit to transfer to stand-by state before the asynchronous modem unit performs the measurement of radio environment (S307) so that the mobile communication terminal is transferred to stand-by state.

As apparent from the foregoing, the asynchronous modem unit refers to the radio environment measurement result to determine whether to perform the handover in response to the asynchronous network transmitting the radio environment measurement control message to the mobile communication terminal. If it is necessary to perform the handover, a synchronization with the synchronous network is obtained, and the mobile communication terminal is handed over to the synchronous network in response to the mobile communication terminal reporting the radio environment measurement result along with the synchronization obtainment information to the asynchronous network. In this case, the necessity of handover is determined by the mobile communication terminal to obtain the synchronization with the synchronous network such that it is possible to drive the synchronous modem unit at an opportune time and to reduce the consumption of power. At the same time, the cutoff of calls due to failure of handover can be prevented by the driving of the synchronous modem unit at an opportune time as the need arises.

While the invention has been shown and described with reference to certain embodiments thereof, it will be understood by those skilled in the art that various changes and modifications in form and details may be made therein without departing from the spirit and scope of the invention as defined by the appended claims. The description of the present invention is intended to be illustrative, and not to limit the scope of the claims.

1. A handover method of dual band dual mode mobile communication system disposed with an asynchronous modem unit and a synchronous modem unit in a mixed mobile communication network of an asynchronous mobile communication system and a synchronous mobile communication system, the method comprising the processes of:
including an adjacent cell information when a transmission/reception signal intensity with a node B of an asynchronous mobile communication system currently connected by a mobile communication terminal is smaller than a designated value to request a handover to the asynchronous mobile communication system so that the asynchronous mobile communication system instructs the asynchronous modem unit of the mobile communication terminal to drive the synchronous modem unit (first process);
determining whether to perform a handover and a handover object cell in the asynchronous mobile communication system to instruct the handover to the synchronous mobile communication system (second process); the asynchronous modem unit of the mobile communication terminal requesting the synchronous modem unit a transfer to the traffic state in response to the asynchronous mobile communication system requesting handover to the asynchronous modem unit of the mobile communication terminal (third process);
the mobile communication terminal being connected to the synchronous mobile communication system (fourth process); and
the asynchronous mobile communication system releasing the connection with the mobile communication terminal (fifth process).

2. The method as defined in claim 1, wherein the first process is a process of the synchronous modem unit of the mobile communication terminal is transferred to stand-by state from the turned-off state by the control of the asynchronous mobile communication system.

3. The method as defined in claim 2, wherein the third process comprises the steps of: the synchronous modem unit of the mobile communication terminal being transferred to ready state from the stand-by state by the control of the asynchronous mobile communication system; and the synchronous modem unit of the mobile communication terminal being transferred to traffic state from the ready state.

4. The method as defined in claim 1, wherein the first process comprises the step of the synchronous modem unit of the mobile communication terminal being transferred to ready state from the turned-off state.

5. The method as defined in claim 1, wherein the first and second processes further comprise the process of the asynchronous mobile communication system referring to the adjacent cell information received from the mobile communication terminal to determine the handover if the adjacent cells are all boundary cells between the asynchronous mobile communication system and the synchronous mobile communication system.

6. The method as defined in claim 1, wherein the first and second processes further comprise the process of the asynchronous modem unit reporting to the asynchronous mobile communication system that the synchronous modem unit has been driven.

7. A handover method of dual band dual mode mobile communication system disposed with an asynchronous modem unit and a synchronous modem unit in a mixed mobile communication network of an asynchronous mobile communication system and a synchronous mobile communication system, the method comprising the processes of:
including an adjacent cell information when a transmission/reception signal intensity with a node B of an asynchronous mobile communication system currently connected by a mobile communication terminal is smaller than a designated value to request a handover to the asynchronous mobile communication system so that the asynchronous mobile communication system instructs an asynchronous modem unit of the mobile communication terminal to transfer the synchronous modem unit to stand-by state from the turned-off state (first process);
the asynchronous modem unit instructing the synchronous modem unit to transfer to ready state from the stand-by state following the asynchronous mobile communication system determining whether to perform the handover (second process);
instructing the synchronous mobile communication system to perform the handover following the asynchronous mobile communication system determining the handover object cell (third process);
the asynchronous modem unit of the mobile communication terminal requesting the synchronous modem unit to transfer to traffic state in response to the asynchronous mobile communication system requesting the asynchronous modem unit of the mobile communication terminal to handover (fourth process);
the mobile communication terminal connecting to the synchronous mobile communication system (fifth process); and
the asynchronous mobile communication system releasing the connection with the mobile communication terminal (sixth process).

8. The method as defined in claim 7, wherein the first and second processes further comprises the process of determining the handover if the adjacent cells are all boundary cells between the asynchronous mobile communication system and the synchronous mobile communication system in response to the asynchronous mobile communication system referring to the adjacent cell information collected by the mobile communication terminal.

9. The method as defined in claim 7, wherein the first and second processes further comprises the process of the asynchronous modem unit of the mobile communication terminal reporting to the asynchronous mobile communication system that the synchronous modem unit has been transferred to stand-by state.

10. A handover method of dual band dual mode mobile communication system disposed with an asynchronous modem unit and a synchronous modem unit in a mixed mobile communication network of an asynchronous mobile communication system and a synchronous mobile communication system, the method comprising the processes of: the asynchronous mobile communication system instructing the asynchronous modem unit of the mobile communication terminal that the synchronous modem unit be driven in response to the mobile communication terminal reporting to the asynchronous mobile communication system the currently-connecting cell and the activated cell information if the activated cells are included with the boundary cells (first process);
the asynchronous mobile communication system determining whether to perform the handover and handover object cell to instruct the synchronous mobile communication system to handover in response to the activated cell information collected from the mobile communication terminal by the asynchronous mobile communication system (second process);
the asynchronous modem unit of the mobile communication terminal requesting the synchronous modem unit to transfer to traffic state in response to the asynchronous mobile communication system requesting the asynchronous modem unit of the mobile communication terminal to handover (third process); the mobile communication terminal connecting to the synchronous mobile communication system (fourth process); and
the asynchronous mobile communication system releasing the connection with the mobile communication terminal (fifth process).

11. The method as defined in claim 10, wherein the first process is a process of the synchronous modem unit of the mobile communication terminal to transfer to stand-by state from the turned-off state in response to the control of the asynchronous mobile communication system.

12. The method as defined in claim 11, wherein the third process comprises the steps of: the synchronous modem unit of the mobile communication terminal transferring to ready state from the stand-by state in response to the control of the asynchronous mobile communication system; and the synchronous modem unit of the mobile communication terminal transferring to traffic state from the ready state.

13. The method as defined in claim 10, wherein the first process comprises the step of the synchronous modem unit of the mobile communication terminal transferring to ready state from the turned-off state in response to the control of the asynchronous mobile communication system.

14. The method as defined in claim 10, wherein the second process is a process of determining the handover if the activated cells are all boundary cells.

15. The method as defined in claim 10, wherein the first and second processes further comprises the process of the asynchronous modem unit of the mobile communication terminal reporting to the asynchronous mobile communication system that the synchronous modem unit has been driven

16. A handover method of dual band dual mode mobile communication system disposed with an asynchronous modem unit and a synchronous modem unit in a mixed mobile communication network of an asynchronous mobile communication system and a synchronous mobile communication system, the method comprising the processes of:
the asynchronous mobile communication system instructing the asynchronous modem unit of the mobile communication terminal that the synchronous modem unit be driven to stand-by state from the turned-off state in response to the mobile communication terminal reporting to the asynchronous mobile communication system the currently-connecting cell and the activated cell information if the activated cells are included with the boundary cells (first process);
the asynchronous mobile communication system referring to the activated cell information of the mobile communication terminal under stand-by state to determine whether to perform the handover, and instructing the asynchronous modem unit that the synchronous modem unit be transferred to ready state from the stand-by state (second process);
the asynchronous mobile communication system determining the handover object cell and instructing the synchronous mobile communication system to handover (third process);
the asynchronous modem unit of the mobile communication terminal requesting the synchronous modem unit to transfer to traffic state in response to the asynchronous mobile communication system requesting the asynchronous modem unit of the mobile communication terminal to perform the handover (fourth process);
the mobile communication terminal connecting to the synchronous mobile communication system (fifth process); and the asynchronous mobile communication system releasing the connection with the mobile communication terminal (sixth process).

17. The method as defined in claim 16, wherein the second process determines the handover if the activated cells of the mobile communication terminal under the stand-by state are all boundary cells.

18. The method as defined in claim 16, wherein the first and second processes further comprises the process of the asynchronous modem unit of the mobile communication terminal reporting to the asynchronous mobile communication system that the synchronous modem unit has been transferred to stand-by state.

19. A handover method of dual band dual mode mobile communication system disposed with an asynchronous modem and a synchronous modem in a mixed mobile communication network of an asynchronous mobile communication system and a synchronous mobile communication system, wherein the synchronous mobile communication system is disposed at a boundary with the asynchronous mobile communication system with a base station transmitting a dummy pilot signal having a same frequency as that used by the asynchronous mobile communication system, the method comprising the processes of:
the asynchronous mobile communication system instructing the asynchronous modem unit of the mobile communication terminal to drive the synchronous modem unit when a boundary cell is contained in an activated cell in response to the mobile communication terminal reporting to the asynchronous mobile communication system information of a cell currently connected by the mobile communication terminal and an activated cell (first process);
determining whether to handover and a handover object cell at the asynchronous mobile communication system when a signal intensity of a cell transmitting a dummy pilot signal out of signals transmitted and received between the mobile communication terminal driven by the synchronous modem unit and an active cell, thereby instructing the handover to the synchronous mobile communication system (second process);
the asynchronous modem unit of the mobile communication terminal requesting the synchronous modem unit to transfer to the traffic state in response to the asynchronous mobile communication system requesting the handover to the asynchronous modem unit of the mobile communication terminal (third process);
the mobile communication terminal being connected to the synchronous mobile communication system (fourth process); and
the asynchronous mobile communication system releasing the connection with the mobile communication terminal (fifth process).

20. The method as defined in claim 19, wherein the first process is a process of the synchronous modem unit of the mobile communication terminal transferring to stand-by state from the turned-off state in response to the control of the asynchronous mobile communication system.

21. The method as defined in claim 20, wherein the third process further comprises the steps of: the synchronous modem unit of the mobile communication terminal transferring to ready state from the stand-by state in response to the control of the asynchronous mobile communication system;
and the synchronous modem unit of the mobile communication terminal transferring to traffic state from the ready state.

22. The method as defined in claim 19, wherein the first process comprises a step of the synchronous modem unit of the mobile communication terminal transferring to ready state from the turned-off state in response to the control of the asynchronous mobile communication system.

23. The method as defined in claim 19, wherein the first and second processes further comprises the process of the asynchronous modem unit of the mobile communication terminal reporting to the asynchronous mobile communication system that the synchronous modem unit has been driven.

24. A handover method of dual band dual mode mobile communication system disposed with an asynchronous modem unit and a synchronous modem unit in a mixed mobile communication network of an asynchronous mobile communication system and a synchronous mobile communication system, the synchronous mobile communication system being equipped with a base station for transmitting a dummy pilot signal having the same frequency as that of the asynchronous mobile communication system in a boundary area with the asynchronous mobile communication system, the method comprising the processes of:
the mobile communication system instructing the asynchronous modem unit of the mobile communication terminal to transfer to stand-by state from the turned-off state in response to the mobile communication terminal reporting the currently-connecting cell and activated cell information to the asynchronous mobile communication system if the boundary cells are included in the activated cells (first process);
the asynchronous mobile communication system determining whether to handover if an intensity of signal transmitted between the activated cells and the mobile communication terminal transferred to stand-by state is larger than that of the signal of a cell transmitting the dummy pilot signal, and instructing the asynchronous modem unit that the synchronous modem unit be transferred to ready state from the stand-by state (second process);
the asynchronous mobile communication system determining the handover object cell and instructing the synchronous mobile communication system to handover (third process);
the asynchronous modem unit of the mobile communication terminal requesting the synchronous modem unit to transfer to traffic state in response to the asynchronous mobile communication system requesting the asynchronous modem unit to handover (fourth process);
the mobile communication terminal connecting to the mobile communication system (fifth process); and
the asynchronous mobile communication system releasing the connection with the mobile communication terminal (sixth process).

25. The method as defined in claim wherein the first and second processes further comprises the process of the asynchronous modem unit of the mobile communication terminal reporting to the asynchronous mobile communication system that the synchronous modem unit has been transferred to stand-by state.

26. A handover method of dual band dual mode mobile communication system disposed with an asynchronous modem unit and a synchronous modem unit in a mixed mobile communication network of an asynchronous mobile communication system and a synchronous mobile communication system, the method comprising the processes of:
the asynchronous mobile communication system reporting to the mobile communication terminal whether a boundary cell exists in an adjacent cell of the mobile communication terminal (first process);
the asynchronous modem unit of the mobile communication terminal discriminates whether to perform a handover if the boundary cell is contained in the adjacent cell of the mobile communication terminal, and the asynchronous mobile communication system instructing the handover to the synchronous mobile communication system in response to driving of the synchronous modem unit and reporting to the asynchronous mobile communication system a synchronization acquisition information (second process);
the asynchronous modem unit of the mobile communication terminal requesting the synchronous modem unit to transfer to the traffic stage in response to the asynchronous mobile communication system requesting the asynchronous modem unit of the mobile communication terminal to perform the handover (third process);
the mobile communication terminal connecting to the synchronous mobile communication system (fourth process); and
the asynchronous mobile communication system releasing the connection with the mobile communication terminal (fifth process).

27. The method as defined in claim 26, wherein the process of driving the synchronous modem unit in the second process further comprises the steps of: the synchronous modem unit of the mobile communication terminal transferring to stand-by state from the turned-off state; and the mobile communication terminal transferring to ready state from the stand-by state.

28. The method as defined in claim 26, wherein the synchronization obtainment information is a PN offset information of the mobile communication system base station.

29. The method as defined in claim 28, wherein the asynchronous mobile communication system refers to the synchronization obtainment information of the synchronous modem unit of the mobile communication terminal, and prompts the mobile communication terminal to instruct the base station that has obtained the synchronization that the handover be made.

30. A handover method of dual band dual mode mobile communication system disposed with an asynchronous modem unit and a synchronous modem unit in a mixed mobile communication network of an asynchronous mobile communication system and a synchronous mobile communication system, the method comprising the processes of:
the asynchronous mobile communication system transmitting radio environment measurement control message to the asynchronous modem unit of the mobile communication terminal (first process);
the asynchronous modem unit of the mobile communication terminal to determine whether to perform the handover in response to the radio environment measurement result, driving the synchronous modem unit, and including the synchronization obtainment information in the radio environment measurement result for report to the asynchronous mobile communication system, whereby the asynchronous mobile communication system instructs the synchronous mobile communication system to perform the handover (second process);
the asynchronous modem unit of the mobile communication terminal requesting the synchronous modem unit to transfer to traffic state in response to the asynchronous mobile communication system requesting the asynchronous modem unit of the mobile communication terminal to perform the handover (third process);
the mobile communication terminal connecting to the synchronous mobile communication system (fourth process); and
the asynchronous mobile communication system releasing the connection with the mobile communication terminal (fifth process).

31. The method as defined in claim 30, wherein the radio environment measurement control message includes a handover condition of the mobile communication terminal.

32. The method as defined in claim 26 further carrying out a process wherein the asynchronous network instructs the synchronous modem unit of the mobile communication terminal to drive the synchronous modem unit before effecting the first process, thereby prompting the synchronous modem unit to transfer to stand-by state.

33. The method as defined in claim 32, wherein the asynchronous modem unit instructs the synchronous modem unit to drive if the adjacent cells of the mobile communication terminal are all the boundary cells.

34. The method as defined in claim 30, wherein the second process is a process of measuring the radio environment following the transition of the synchronous modem unit of the mobile communication terminal to stand-by state, and the mobile communication terminal under stand-by state transferring to ready state and then being driven.
